(19) United States
(12) Patent Application Publication
(10) Pub. No.: US 2005/0127252 A1
(43) Pub. Date: Jun. 16, 2005

(54) Device for accomodating a flat screen in the dome of an automobile

(76) Inventor: Thomas Fischer, Oberkollbach (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/221,111

(22) PCT Filed: Feb. 23, 2001
(86) PCT No.: PCT/EP01/02058

(30) Foreign Application Priority Data
Mar. 7, 2000 (DE) 100 10 991.8

(51) Int. Cl. F16M 11/00

(52) U.S. Cl. 248/176.1; 248/917

(57) ABSTRACT

It is an object of the invention to provide an apparatus for holding a flat screen in the dome of a motor vehicle which permits space-saving release of components arranged behind the flat screen. In the inventive apparatus, free accessibility of the components arranged behind the flat screen is achieved by virtue of the flat screen being able to be moved in the apparatus such that, during its motion, it does not project into the passenger compartment out of the window in the panel covering the flat screen. The invention is used for holding a flat screen, particularly an LCD (Liquid Crystal Display), in the dome of a motor vehicle. The LCD covers components which are used, by way of example, for playing back information media for entertaining the vehicle occupants.

### BACKGROUND AND SUMMARY OF THE INVENTION

This application claims the priority of German priority document 100 10 991.8, filed 7 Mar. 2000 (PCT International Application No. PCT/EP01/02058, filed 23 Feb. 2001), the disclosure of which is expressly incorporated by reference herein.

The invention relates to an apparatus for holding a flat screen in the mounting surface of a motor vehicle.

In motor vehicles today, components with an LCD (Liquid Crystal Display) are used to provide graphic navigational assistance to the vehicle driver. In addition, motor vehicles are equipped with various further components for information and entertainment purposes, such as drives for playable DVD, CD, minidisc and CC information media, whose operation is likewise assisted by the flat screen.

For ergonomic reasons, these components need to be arranged within the driver's reach; and it is known to arrange the drives for the aforementioned information media behind the LCD. The LCD in turn is held in a panel with the control elements for the components and can be displaced in order to load the information media into the drives.

In a known apparatus of this type, such as is disclosed for example in European Patent Document EP 0338405 B1, the panel containing the LCD requires sufficient free space in the adjoining passenger compartment to swing through 90° in order to release the drives. This can result in conflicts in the arrangement of the gear lever and other components in the mounting surface area (for example, a holder for a drinking cup, or switches or control elements for air-conditioning units).

It is an object of the invention to provide an apparatus for holding a flat screen in the mounting surface of a motor vehicle which permits space-saving release of components arranged behind the flat screen.

This and other objects and advantages are achieved by the mounting apparatus according to the invention, which uses a fixed panel. To release the drives, only the flat screen arranged behind the panel is moved by means of a driving motor. The motion is guided in such a manner that the flat screen does not project into the adjoining passenger compartment, so that no adjacent components can collide with the flat screen.

The fixed panel has the advantage that is not necessary to move all the connecting cables for the control elements arranged on the panel when releasing the drives. It also allows better design in that the mechanical driving elements necessary for the displacement can be hidden behind the panel. In addition, this principle produces simple, solid solutions for holding the displaceable flat screen in the limited space which is available. Moreover, it is also not possible for cups or other objects to be placed on a folded-out flat screen and to fall therefrom.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a sectional side view of an apparatus in accordance with the invention;

FIG. 2 shows a front view of the apparatus;

FIG. 3 shows a perspective view of the apparatus with the guides for displacement of the flat screen, and a flat screen position which releases the top drive's loading opening; and

FIG. 4 shows the apparatus in a flat screen position that releases the bottom drive's loading opening.

### DETAILED DESCRIPTION OF THE DRAWINGS

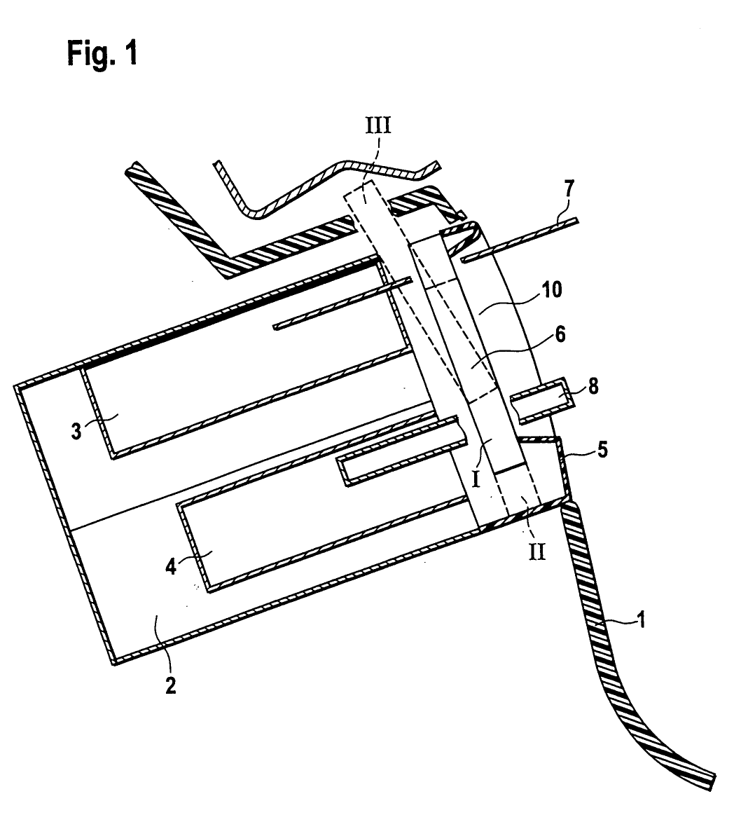

The exemplary embodiment of the invention shown in FIG. 1 is fitted in the mounting surface 1 of a motor vehicle and has a unit housing 2, a drive 3, a drive 4, a panel 5 and a flat screen 6.

The drives 3 and 4 are arranged above one another in the unit housing 2, and the opening in the unit housing 2, which opening opens towards the passenger compartment, contains the flat screen 6 in the panel 5 of the unit housing in such a manner that it can be displaced vertically. Alternatively, with suitable space circumstances, the flat screen could also be displaced horizontally. The flat screen 6 used in the exemplary embodiment is, by way of example, an LCD (Liquid Crystal Display); alternatively, other flat screens can also be used, however. The displaceable flat screen 6 is screened from the passenger compartment by the fixed panel 5 and can be read through a window 10 made in the panel 5.

The flat screen 6 can be displaced into three different positions by means of motor drive. (As an alternative to displacement by motor, manual displacement is also possible.) In FIG. 1, the flat screen 6 in the normal position—“I”—in which both of the two drives 3 and 4 are blocked from the passenger compartment by the flat screen 6 is shown with a solid line. For the drive loading positions which can be adopted as alternatives—“II” and “III”—the flat screen 6 is indicated with a dashed line.

In position “II”, the top drive 3 is opened for loading with an information medium 7, and in position “III” the bottom drive 4 is opened for loading with an information medium 8. Position “II” is reached from the normal position “I” by displacing the flat screen 6 vertically downwards. The flat screen 6 is displaced into position “III” from the normal position “I” by vertical displacement upwards while simultaneously tilting it into the unit housing 2. In this case, the flat screen 6 is tilted away only at an angle backwards; the tilting angle is less than 90°. The flat screen's tilting taking place in the exemplary embodiment is necessary only if the space circumstances in the dome are tight. The inventive displacement of the flat screen 6 can also be coupled to prior movement of the flat screen away from the back wall of the panel 5.

In the exemplary embodiment shown, the drive 3 is a DVD drive, and the drive 4 is a CC drive. Instead of the aforementioned drives, it is also possible for any other components which the vehicle occupants might wish to access as required to be arranged behind the flat screen.

Also, the inventive solution is not limited to covering a DVD drive and a CC drive, or to the order shown here—DVD drive above CC drive. Any other drives for playing back information media can be arranged above one another in any order, and the number of drives arranged above one another is not limited to two drives. Instead of drives, it is also possible for the flat screen 6 to cover other components which require temporary, free access from the passenger compartment in order to operate them.

With appropriate space circumstances, it would also be possible to approach releasing a bottom drive just by displacing the flat screen 6 vertically upwards, without tilting it away backwards, or a top drive could be released by displacing the flat screen 6 vertically downwards while simultaneously tilting it away backwards. That is, one aspect of the invention lies in the vertical or horizontal displacement (and possibly tilting-away) of the flat screen 6 without its projecting into the passenger compartment in the process.

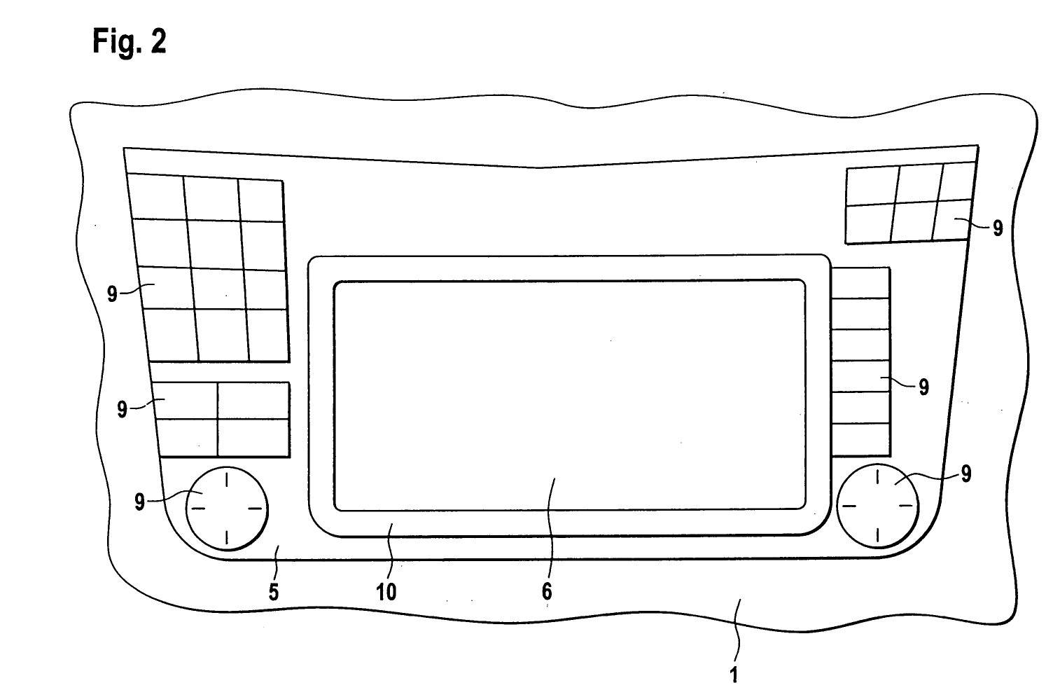

The front view of the apparatus shown in FIG. 2 shows the panel 5 fixed in the mounting surface 1 with the window 10 and control elements 9 for drives, navigation systems and other components for information or entertainment purposes. The flat screen 6 can be read through the window 10 by the vehicle occupants, or, when the flat screen has been displaced from the normal position, the drives 3, 4 behind it can be loaded manually with information media 7, 8 through the window 10, or other components which are not operated from the panel can be operated manually in this way.

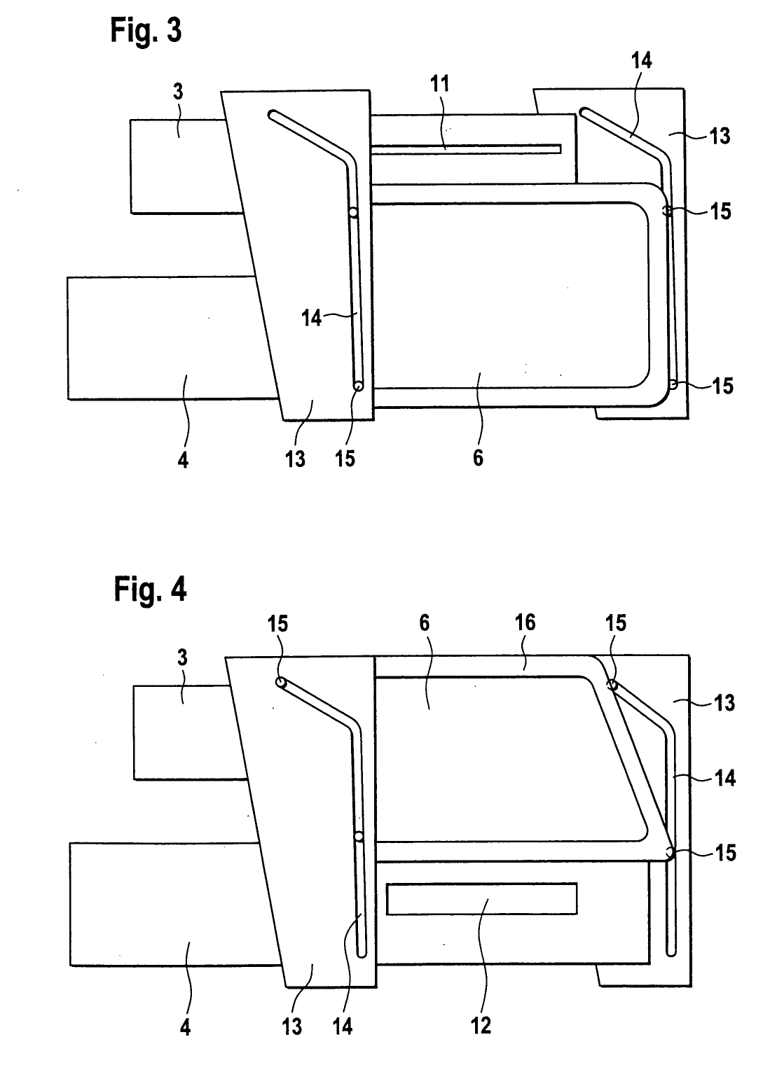

In the apparatus shown in perspective in FIG. 3, the guides for displacing the flat screen can be seen. The flat screen 6 is guided on both sides by guide pins 15 in guide slots 14 which are formed in the side walls 13 of the unit housing 2. The drive for displacing the flat screen 6 (not shown in FIG. 3) is provided by motor using a mechanical drive unit and can be controlled electrically by a suitably designed control element 9 on the panel 5—such as by a rocker switch. In FIG. 3, the flat screen 6 has been displaced into its position “II”, in which the loading opening 11 of the top drive 3 is freely accessible for the associated information medium 7.

FIG. 4 shows a perspective view of the apparatus, with the freely accessible loading opening 12 for the bottom drive 4. To achieve this situation, the flat screen 6 has been displaced vertically upwards and tilted backwards into its position “III”. The displacement motions of the flat screen 6 are prescribed by the shape of the guide slots 14 and by the arrangement of the guide pins 15 on the flat screen.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Apparatus for holding a flat display screen in a mounting surface of a motor vehicle having components for playing back information media, said apparatus comprising:
a panel arranged in front of said components towards a passenger compartment of the vehicle, wherein:
the flat screen incorporated into the panel; and
access to the components is achieved by virtue of the flat screen being movable in the apparatus such that, during its motion, it does not project into the passenger compartment out of the window in the panel.

2. The apparatus according to claim 1, wherein:
the panel is fixed immovably in the mounting surface; and
only the flat screen is moved to access the components covered by the flat screen.

3. The apparatus according to claim 1, wherein:
the flat screen displays information from a navigation system; and
the components covered by the flat screen are two drives with loading openings for playing back information media.

4. The apparatus according to claim 1, wherein:
the flat screen is movable by motor via mechanical driving elements arranged behind the panel.

5. Flat screen display apparatus for a motor vehicle, comprising:
a flat display screen; and
a panel fixedly mounted on a mounting surface in an interior of the vehicle; wherein
said display screen is translationally movable within said panel, between at least first and second positions, without projecting into the interior of the vehicle during movement thereof;
in said first position said display screen is visible to the vehicle interior, and blocks access to vehicle components that are situated behind said panel; and
in said second position of said display screen, said components are accessible to the vehicle interior.

6. The apparatus according to claim 5, wherein translational movement of said display comprises one of a vertical and a horizontal movement, without rotation of said screen into the vehicle interior.

7. The apparatus according to claim 6, wherein at least one edge of said display screen rotates away from said vehicle interior in addition to said translational movement.

8. The apparatus according to claim 5, wherein:
said panel includes a window;
in said first position said display screen is situated behind and is visible through said window; and
in said second position said display screen is translated away from said window and said components are accessible through said window.
